(19) United States
(12) Patent Application Publication
(10) Pub. No.: US 2024/0118768 A1
(43) Pub. Date: Apr. 11, 2024

(54) DIAGNOSIS DEVICE AND DIAGNOSIS METHOD

(71) Applicant: FANUC CORPORATION, Yamanashi (JP)

(72) Inventors: Hiroyuki KATAYA, Yamanashi-ken (JP); Yasumichi SAKODA, Yamanashi-ken (JP)

(21) Appl. No.: 18/263,898

(22) PCT Filed: Jan. 31, 2022
(86) PCT No.: PCT/JP2022/003485

§ 371 Date: Aug. 2, 2023

(30) Foreign Application Priority Data
Feb. 12, 2021 (JP) 2021-021003

(51) Int. Cl. G06F 3/041; G06F 3/044

(52) U.S. Cl. CPC G06F 3/0418; G06F 3/044

(57) ABSTRACT

A diagnosis device according to one embodiment determines the state of a touch panel, on the basis of: a first signal intensity detected at each of a plurality of coordinates provided on the touch panel in a self-capacitance manner; and a second signal intensity detected at each of the plurality of coordinates in a mutual capacitance manner.

### TECHNICAL FIELD

The present invention relates to a diagnosis device and a diagnosis method configured to diagnose an electrostatic capacitive touch panel.

### BACKGROUND ART

A machine tool equipped with a touch panel has conventionally been disclosed, for example, in JP 2016-004337 A.

### SUMMARY OF THE INVENTION

In a factory or the like in which a machine tool is in operation, contaminants such as cutting chips and the like generated by the machine tool during machining can easily adhere to a touch surface of the touch panel. Due to these contaminants, the capacitance of the touch panel is changed. However, the machine tool is incapable of recognizing whether the change in capacitance is caused as a result of the contaminants adhering to the touch surface. Accordingly, the machine tool is incapable of acquiring the state of the touch panel.

Thus, the present invention has the object of providing a diagnosis device and a diagnosis method, which are capable of perceiving the state of a touch panel in fine detail.

A first aspect of the present invention is characterized by a diagnosis device that diagnoses a touch panel that is an electrostatic capacitive touch panel configured to detect signals based on each of self-capacitance and mutual capacitance, the diagnosis device comprising a control unit configured to control the touch panel in a manner so that detection of a signal based on the self-capacitance and detection of a signal based on the mutual capacitance are executed, a signal intensity acquisition unit configured to acquire a first signal intensity detected based on the self-capacitance at each of a plurality of coordinates provided on the touch panel, and a second signal intensity detected based on the mutual capacitance at each of the plurality of coordinates, and a state determination unit configured to determine a state of the touch panel based on each of the first signal intensities and each of the second signal intensities that are acquired.

A second aspect of the present invention is characterized by a diagnosis method for diagnosing a touch panel that is an electrostatic capacitive touch panel configured to detect signals based on each of self-capacitance and mutual capacitance, the diagnosis method comprising a control step of controlling the touch panel in a manner so that detection of a signal based on the self-capacitance and detection of a signal based on the mutual capacitance are executed, a signal intensity acquisition step of acquiring a first signal intensity detected based on the self-capacitance at each of a plurality of coordinates provided on the touch panel, and a second signal intensity detected based on the mutual capacitance at each of the plurality of coordinates, and a state determination step of determining a state of the touch panel based on each of the first signal intensities and each of the second signal intensities that are acquired.

According to the aspects of the present invention, in comparison with a case in which only the first signal intensities or the second signal intensities are acquired, the state of the touch panel can be perceived more finely and in greater detail.

### BRIEF DESCRIPTION OF DRAWINGS

FIG. 1 is a block diagram illustrating the configuration of a display system;

FIG. 2 is a block diagram illustrating the configuration of a state determination unit;

FIG. 3 is a diagram illustrating a determination criteria of the state determination unit;

FIG. 4 is a block diagram illustrating the configuration of a notification unit;

FIG. 5 is a diagram illustrating a display example of a state of a touch panel;

FIG. 6 is a flowchart showing a procedure of a diagnostic process in the case that a processor is made to execute a diagnostic program;

FIG. 7 is a block diagram illustrating the configuration of one portion of a diagnosis device according to an Exemplary Modification 1; and

FIG. 8 is a block diagram illustrating the configuration of one portion of a diagnosis device according to an Exemplary Modification 2.

### DETAILED DESCRIPTION OF THE INVENTION

### Embodiment

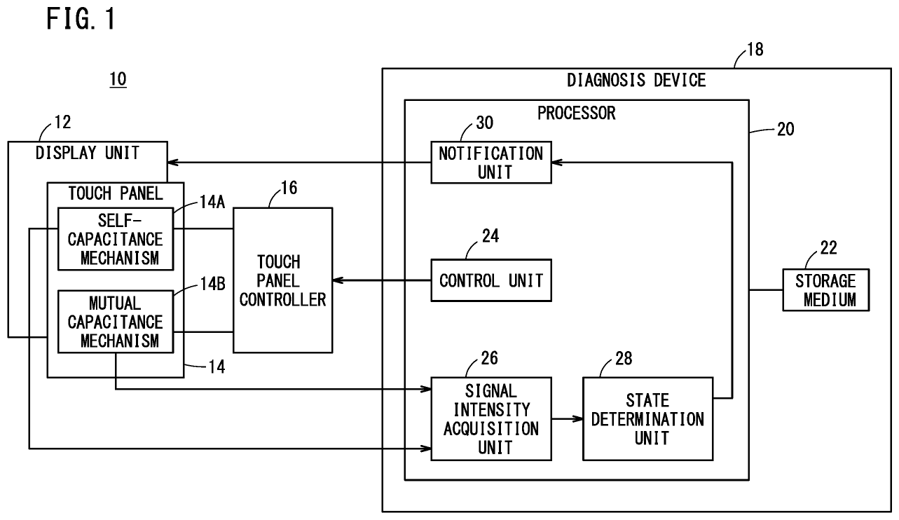

FIG. 1 is a block diagram showing the configuration of a display system 10. The display system 10 is equipped with a display unit 12, a touch panel 14, a touch panel controller 16, and a diagnosis device 18.

The display unit 12 is a liquid crystal display or the like. The display unit 12 displays icons for the purpose of inputting commands to the diagnosis device 18, information delivered from the diagnosis device 18, and the like.

The touch panel 14 is an electrostatic capacitive touch panel. The touch panel 14 is formed in a transparent film shape, and is disposed on a screen of the display unit 12. The touch panel 14 includes a self-capacitance mechanism 14A and a mutual capacitance mechanism 14B.

The self-capacitance mechanism 14A is a mechanism that identifies an operation position based on a principle of detecting a capacitance between a single electrode and the human body. The self-capacitance mechanism 14A detects first signal intensities at a plurality of coordinates provided on the touch panel 14, and identifies the operation position on the basis of the detected first signal intensities. The process of the self-capacitance mechanism 14A can be arbitrarily selected from among well-known processes. Accordingly, a detailed explanation of such a process will be omitted herein.

The mutual capacitance mechanism 14B is a mechanism that identifies an operation position based on a principle of detecting a change in an electric field between a transmission electrode and a reception electrode. The mutual capacitance mechanism 14B detects second signal intensities at the plurality of coordinates provided on the touch panel 14, and identifies the operation position on the basis of the detected second signal intensities. The process of the mutual capacitance mechanism 14B can be arbitrarily selected from among well-known processes. Accordingly, a detailed explanation of such a process will be omitted herein.

Moreover, the plurality of coordinates provided on the touch panel 14 indicate positions of the touch panel 14. The plurality of coordinates provided on the touch panel 14 are specified by a combination of lines of X-axis electrodes arranged in the X-axis direction of the touch panel 14, and lines of Y-axis electrodes arranged in the Y-axis direction of the touch panel 14. For example, in the case that the X-axis electrodes are designated by Ex (Ex[1] to Ex[m]) and the Y-axis electrodes are designated by Ey (Ey[1] to Ey[n]), the coordinates are defined as [1, 1] to [m, n].

In addition, the plurality of coordinates detected by the self-capacitance mechanism 14A and the plurality of coordinates detected by the mutual capacitance mechanism 14B indicate similar positions. Stated otherwise, for the plurality of coordinates provided on the touch panel 14, the self-capacitance mechanism 14A detects the first signal intensities, and the mutual capacitance mechanism 14B detects the second signal intensities.

The touch panel controller 16 serves to control the touch panel 14. The touch panel controller 16 controls the touch panel 14 based on either one of a self-capacitance mode for the purpose of driving the self-capacitance mechanism 14A, or a mutual capacitance mode for the purpose of driving the mutual capacitance mechanism 14B.

In the case that the touch panel 14 is controlled based on the self-capacitance mode, the touch panel controller 16 periodically transmits drive pulse signals with a set number of pulses that are set by the self-capacitance mode. In this case, the self-capacitance mechanism 14A periodically detects the first signal intensities at the plurality of coordinates, with the drive pulse signals with the set number of pulses acting as one unit.

On the other hand, in the case that the touch panel 14 is controlled based on the mutual capacitance mode, the touch panel controller 16 periodically transmits drive pulse signals with a set number of pulses that are set by the mutual capacitance mode. In this case, the mutual capacitance mechanism 14B periodically detects the second signal intensities at the plurality of coordinates, with the drive pulse signals with the set number of pulses acting as one unit.

The diagnosis device 18 diagnoses the state of the touch panel 14. The diagnosis device 18 may be a display control device that controls the display unit 12, a numerical control device that controls a machine tool, or a general-purpose personal computer. Moreover, in the case that the diagnosis device 18 is a numerical control device, the touch panel 14 is used as an input device for the numerical control device.

The diagnosis device 18 includes a processor 20 such as a CPU and an MPU, and a storage medium 22 including various memories such as a ROM, a RAM, and a hard disk. The diagnosis device 18 causes the processor 20 to execute a diagnostic program that is stored in the storage medium 22. When the diagnostic program is executed, the processor 20 operates as a control unit 24, a signal intensity acquisition unit 26, a state determination unit 28, and a notification unit 30. Moreover, at least one of the signal intensity acquisition unit 26, the state determination unit 28, or the notification unit 30 may be implemented by an integrated circuit such as an ASIC and an FPGA. Further, at least one of the signal intensity acquisition unit 26, the state determination unit 28, or the notification unit 30 may be constituted by an electronic circuit including a discrete device.

The control unit 24 controls the touch panel 14 in a manner so that detection of the self-capacitance signals and detection of the mutual capacitance signals are executed. The control unit 24 requests the touch panel controller 16 to execute the self-capacitance mode and the mutual capacitance mode. Consequently, the touch panel controller 16 causes the self-capacitance mechanism 14A and the mutual capacitance mechanism 14B to be driven. Moreover, it should be noted that the control unit 24 may alternately cause the self-capacitance mechanism 14A and the mutual capacitance mechanism 14B to be driven one time each, or may alternatively cause them to be driven in a preset order.

The signal intensity acquisition unit 26, at the plurality of coordinates, acquires the first signal intensities detected based on the self-capacitance, and the second signal intensities detected based on the mutual capacitance. More specifically, by executing the self-capacitance mode, the signal intensity acquisition unit 26 acquires the first signal intensities at the coordinates detected by the self-capacitance mechanism 14A. Further, by executing the mutual capacitance mode, the signal intensity acquisition unit 26 acquires the second signal intensities at the coordinates detected by the mutual capacitance mechanism 14B.

The state determination unit 28 determines the state of the touch panel 14 based on each of the first signal intensities and each of the second signal intensities. Details concerning the state determination unit 28 will be described later.

The notification unit 30 issues a notification concerning the determination result of the state determination unit 28. Using at least one of a speaker or the display unit 12, the notification unit 30 can provide a notification of the determination result of the state determination unit 28. In accordance with this feature, it is possible to make the operator who operates the touch panel 14 grasp the state of the touch panel 14.

Moreover, in the case of using a speaker, the notification unit 30 provides a notification of the determination result of the state determination unit 28 by controlling the speaker. For example, the notification unit 30 causes the speaker to output a sound indicating the determination result of the state determination unit 28. In the case of using the display unit 12, the notification unit 30 causes the determination result of the state determination unit 28 to be displayed on the screen of the display unit 12 by controlling the display unit 12. Details concerning such a display will be described later.

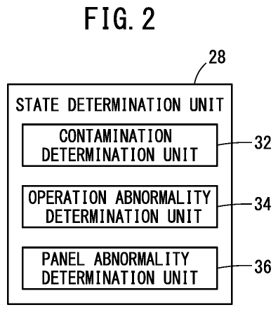

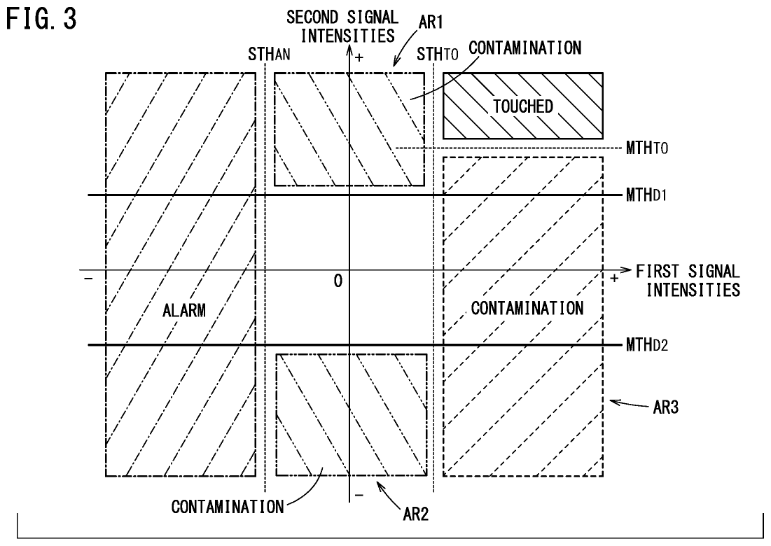

FIG. 2 is a block diagram illustrating the configuration of the state determination unit 28, and FIG. 3 is a diagram illustrating a determination criteria of the state determination unit 28. The state determination unit 28 includes a contamination determination unit 32, an operation abnormality determination unit 34, and a panel abnormality determination unit 36.

The contamination determination unit 32 determines the presence of contamination on the touch surface of the touch panel 14, based on each of the first signal intensities and each of the second signal intensities acquired by the signal intensity acquisition unit 26. Within a range in which the first signal intensities and the second signal intensities behave, there are a first range AR1, a second range AR2, and a third range AR3 which are highly reliable as an indicator for estimating the presence of contamination.

In the self-capacitance mode, the first range AR1 is a range in which the signal intensities are less than a self-capacitance touch threshold STH_{TO} and in excess of an abnormality threshold STH_{AN}. Furthermore, in the mutual capacitance mode, the first range AR1 is a range in which the signal intensities are greater than or equal to a positive side threshold MTH_{D1}. Moreover, the self-capacitance touch threshold STH_{TO} is a threshold that is set in order to determine that a touch operation has been performed based on the self-capacitance. The abnormality threshold STH_{AN} is a threshold that is set in order to determine that the touch panel 14 is in an abnormal state. The positive side threshold MTH_{D1} is a threshold that is set in order to determine whether the touch surface is contaminated. The positive side threshold MTH_{D1} is set to be lower than a mutual capacitance touch threshold MTH_{TO}, and is set more on the positive side than a reference value forming a positive/negative boundary.

In the first range AR1, in the case that contamination is adhered to the touch surface in a state in which a metallic frame of the display unit 12 is not touched, there is a tendency for the first signal intensities and the second signal intensities to appear. In the case that the second signal intensities at specified coordinates at which the first signal intensities are less than the self-capacitance touch threshold STH_{TO} and in excess of the abnormality threshold STH_{AN} are greater than or equal to the positive side threshold MTH_{D1}, the contamination determination unit 32 determines that the touch surface corresponding to the specified coordinates is contaminated. In accordance with this feature, it is possible to correctly perceive that contamination is adhered to specified positions.

In the self-capacitance mode, the second range AR2 is a range in which the signal intensities are less than the self-capacitance touch threshold STH_{TO} and in excess of the abnormality threshold STH_{AN}. Furthermore, in the mutual capacitance mode, the second range AR2 is a range in which the signal intensities are less than or equal to a negative side threshold MTH_{D2}. Moreover, the negative side threshold MTH_{D2} is a threshold that is set in order to determine whether the touch surface is contaminated. The negative side threshold MTH_{D2} is set to be lower than the mutual capacitance touch threshold MTH_{TO} and the positive side threshold MTH_{D1}, and is set more on the negative side than the reference value forming the positive/negative boundary.

In the second range AR2, in the case that contamination is adhered to the touch surface in a state in which the metallic frame of the display unit 12 is not touched, there is a tendency for the first signal intensities and the second signal intensities to appear. In the case that the second signal intensities at specified coordinates at which the first signal intensities are less than the self-capacitance touch threshold STH_{TO} and in excess of the abnormality threshold STH_{AN} are less than or equal to the negative side threshold MTH_{D2}, the contamination determination unit 32 determines that the touch surface corresponding to the specified coordinates is contaminated. In accordance with this feature, it is possible to correctly perceive that contamination is adhered to specified positions.

In the self-capacitance mode, the third range AR3 is a range in which the signal intensities are greater than or equal to the self-capacitance touch threshold STH_{TO}. Furthermore, in the mutual capacitance mode, the third range AR3 is a range in which the signal intensities are less than the mutual capacitance touch threshold MTH_{TO}.

In the third range AR3, in the case that contamination is adhered to the touch surface in a state in which a frame of the touch panel 14 is touched, there is a tendency for the first signal intensities and the second signal intensities to appear.

In the case that the second signal intensities at specified coordinates at which the first signal intensities are greater than or equal to the self-capacitance touch threshold STH_{TO} are less than the mutual capacitance touch threshold MTH_{TO}, the contamination determination unit 32 determines that the touch surface corresponding to the specified coordinates is contaminated. In accordance with this feature, it is possible to correctly perceive that contamination is adhered to specified positions.

The operation abnormality determination unit 34 determines the presence of an operation abnormality with respect to the touch surface of the touch panel 14, based on each of the first signal intensities and each of the second signal intensities acquired by the signal intensity acquisition unit 26. In the case that the second signal intensities at specified coordinates at which the first signal intensities are greater than or equal to the self-capacitance touch threshold STH_{TO} are greater than or equal to the mutual capacitance touch threshold MTH_{TO}, the operation abnormality determination unit 34 detects the specified coordinates as being operation positions.

The operation abnormality determination unit 34 counts, as the number of operation points, the number of operation positions that have been detected. Moreover, the number of operation points is reset in units of cycles of detecting the first signal intensities and the second signal intensities at the plurality of coordinates on the touch panel 14. In the case that the number of specified coordinates exceeds a number-of-operation points threshold, the operation abnormality determination unit 34 determines that there is an operation abnormality with respect to the touch surface. In accordance with this feature, in comparison with the case in which the operation positions are determined using only the first signal intensities or the second signal intensities, an abnormality in the number of the operation points can be perceived more accurately.

The panel abnormality determination unit 36 determines the presence of an abnormality in the touch panel 14, based on each of the first signal intensities acquired by the signal intensity acquisition unit 26. In general, if the touch panel 14 is normal, the first signal intensities assume a positive value. Therefore, the abnormality threshold STH_{AN} is set to zero or a value in close proximity to zero. In the case that there is at least one first signal intensity that is less than or equal to the abnormality threshold STH_{AN}, the panel abnormality determination unit 36 determines that the touch panel 14 is abnormal. In accordance with this feature, an abnormality can be perceived correctly and immediately.

Moreover, the state determination unit 28 may determine that the touch panel 14 is normal in the case that all of the following three conditions are satisfied. The first condition is a case in which the contamination determination unit 32 does not determine that the touch surface is contaminated. The second condition is a case in which the operation abnormality determination unit 34 does not determine that an operation abnormality exists with respect to the touch surface. The third condition is a case in which the panel abnormality determination unit 36 does not determine that there is an abnormality in the touch panel 14.

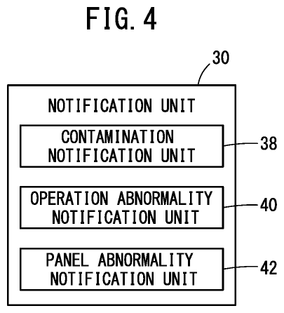

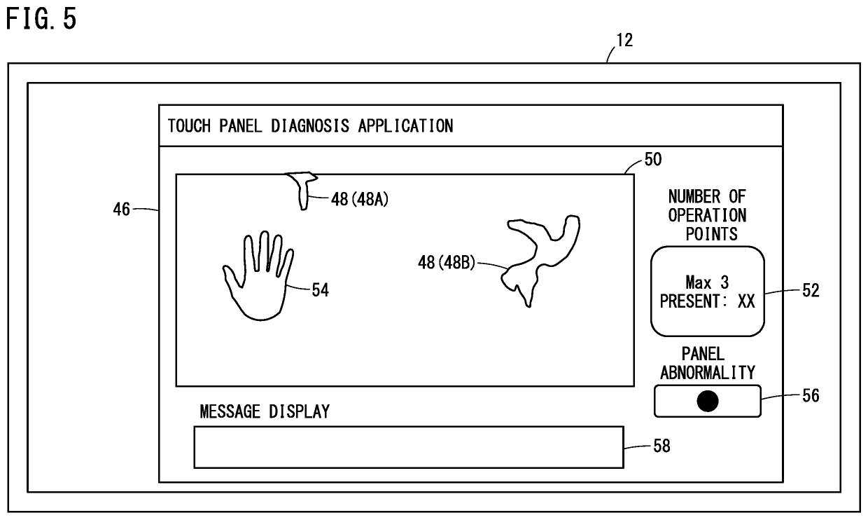

FIG. 4 is a block diagram illustrating the configuration of the notification unit 30, and FIG. 5 is a diagram illustrating a display example of a state of the touch panel 14. The notification unit 30 includes a contamination notification unit 38, an operation abnormality notification unit 40, and a panel abnormality notification unit 42. In the case of issuing a notification of the determination result of the state determination unit 28 using the display unit 12, the notification unit 30 causes a diagnosis screen 46 to be displayed on a display screen of the display unit 12.

The contamination notification unit 38 causes contamination images 48 (48A and 48B) to be displayed on a panel scaled-down screen 50 within the diagnosis screen 46, on the basis of the specified coordinates that have been determined by the contamination determination unit 32 to be contaminated. The contamination images 48 (48A and 48B) are images showing contaminated locations on the touch panel 14. In accordance with this feature, it is possible to provide a notification of the contaminated locations in an easily understandable manner to the operator who operates the touch panel 14.

The operation abnormality notification unit 40 causes the number of operation points to be displayed in a predetermined display field 52 within the diagnosis screen 46, based on the specified coordinates detected by the operation abnormality determination unit 34 in the case that the operation abnormality determination unit 34 has determined that there is an operation abnormality with respect to the touch surface. In accordance with this feature, it is possible to make the operator who operates the touch panel 14 grasp the number of operation points. In the case that a number that differs from the number of actual operation points by the operator is displayed, it is possible to indirectly call to the operator's attention that the touch surface is contaminated or the like. Moreover, the operation abnormality notification unit 40 may cause the number of operation points to be displayed together with the number-of-operation points threshold. In FIG. 5, the number-of-operation points threshold is stated as a maximum value.

Further, the operation abnormality notification unit 40 causes an operation image 54 to be displayed on the panel scaled-down screen 50 within the diagnosis screen 46, based on the specified coordinates detected by the operation abnormality determination unit 34 in the case that the operation abnormality determination unit 34 has determined that there is an operation abnormality with respect to the touch surface. The operation image 54 is an image showing the current operation site. In accordance with this feature, the operator who operates the touch panel 14 can be easily notified of an improperly operated state.

In the case that the panel abnormality determination unit 36 determines that the touch panel 14 is abnormal, the panel abnormality notification unit 42 causes an alarm button 56 within the diagnosis screen 46 to flash, for example. In accordance with this feature, it is possible to provide a notification to the operator who operates the touch panel 14 that the touch panel 14 is abnormal.

Moreover, in addition to the determination result of the state determination unit 28, the notification unit 30 may issue a notification of a message indicating a countermeasure for such a determination result. For example, in the case it is determined by the contamination determination unit 32 that the touch surface is contaminated, the notification unit 30 causes characters such as “please wipe off the contamination” to be displayed in a message field 58 within the diagnosis screen 46. Consequently, it is possible to provide a notification of a message prompting the operator to remove the contamination. Further, in the case it is determined by the operation abnormality notification unit 40 that there is an operation abnormality with respect to the touch surface, the notification unit 30 causes characters such as “please stop touching temporarily” to be displayed in the message field 58 within the diagnosis screen 46. Consequently, it is possible to provide a notification of a message prompting the operator to wait for the touch operation. Further, in the case it is determined by the panel abnormality notification unit 42 that the touch panel 14 is abnormal, the notification unit 30 causes characters such as “please contact the service department of the manufacturer” to be displayed in the message field 58 within the diagnosis screen 46. Consequently, it is possible to provide a notification of a message prompting the operator to contact a service department of the manufacturer.

In this manner, the notification unit 30 issues a notification of a message indicating a countermeasure for the determination result of the state determination unit 28. In accordance with this feature, it is possible to convey in an easily understandable manner to the operator who operates the touch panel 14 how to carry out an improvement or the like when the state of the touch panel 14 is poor. Moreover, it should be noted that the message may be provided by way of voice.

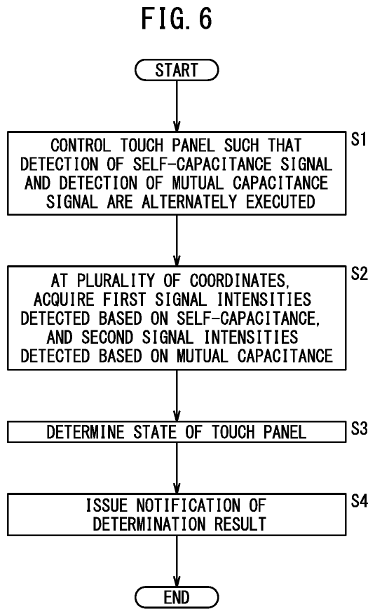

Next, a description will be given concerning a diagnosis method of the diagnosis device 18. FIG. 6 is a flowchart showing a procedure of a diagnostic process in the case that the processor 20 is made to execute the diagnostic program.

In step S1, the control unit 24 controls the touch panel 14 in a manner so that detection of the self-capacitance signal and detection of the mutual capacitance signal are executed. More specifically, the control unit 24 requests the touch panel controller 16 to execute the self-capacitance mode and the mutual capacitance mode. Consequently, the touch panel controller 16 causes the self-capacitance mechanism 14A and the mutual capacitance mechanism 14B to be driven. When the request from the control unit 24 with respect to the touch panel controller 16 is completed, the diagnostic process transitions to step S2.

In step S2, the signal intensity acquisition unit 26 acquires the first signal intensities detected by the self-capacitance mechanism 14A and the second signal intensities detected by the mutual capacitance mechanism 14B at the plurality of coordinates. When the first signal intensities and the second signal intensities at plurality of coordinates are acquired, the diagnostic process transitions to step S3.

In step S3, on the basis of the first signal intensities and the second signal intensities at the plurality of coordinates, the state determination unit 28 determines the state of the touch panel 14.

In the case that the second signal intensities at specified coordinates at which the first signal intensities are less than the self-capacitance touch threshold STH_{TO} and in excess of the abnormality threshold STH_{AN} are greater than or equal to the positive side threshold MTH_{D1} or less than or equal to the negative side threshold MTH_{D2}, the state determination unit 28 determines that the touch surface corresponding to the specified coordinates is contaminated. Further, in the case that the second signal intensities at specified coordinates at which the first signal intensities are greater than or equal to the self-capacitance touch threshold STH_{TO} are less than the mutual capacitance touch threshold MTH_{TO}, the state determination unit 28 determines that the touch surface corresponding to the specified coordinates is contaminated. Further, in the case that the second signal intensities at specified coordinates at which the first signal intensities are greater than or equal to the self-capacitance touch threshold STH_{TO} are greater than or equal to the mutual capacitance touch threshold MTH_{TO}, the state determination unit 28 detects the specified coordinates as being operation positions. In such a case, in the case that the number of specified coordinates detected as being operation positions exceeds the number-of-operation points threshold, the state determination unit 28 determines that there is an operation abnormality with respect to the touch surface. Further, in the case that there is at least one first signal intensity that is less than or equal to the abnormality threshold STH_{AN}, the state determination unit 28 determines that the touch panel 14 is abnormal. Moreover, when none of these cases apply, the state determination unit 28 may determine that the touch panel 14 is normal. When the state of the touch panel 14 is determined, the diagnostic process transitions to step S4.

In step S4, the notification unit 30 issues a notification concerning the determination result of the state determination unit 28. After having provided the notification concerning the determination result, the diagnostic process comes to an end.

Moreover, each of steps S2 to S4 of the diagnostic process may be executed a plurality of times in units of n cycles of detecting the first signal intensities and the second signal intensities at the plurality of coordinates on the touch panel 14. The variable “n” is an integer of one or more. Further, each of steps S2 to S4 of the diagnostic process may be executed in units of n cycles of detecting the first signal intensities and the second signal intensities at the plurality of coordinates on the touch panel 14, until a predetermined diagnostic period has elapsed. Further, each of steps S2 to S4 of the diagnostic process may be executed in units of n cycles of detecting the first signal intensities and the second signal intensities at the plurality of coordinates on the touch panel 14, until a diagnosis termination operation is carried out by the operator.

In the foregoing manner, according to the present embodiment, the first signal intensities detected based on the self-capacitance and the second signal intensities detected based on the mutual capacitance are acquired at the plurality of coordinates. Further, according to the present embodiment, the state of the touch panel 14 is determined based on the first signal intensities and the second signal intensities that have been acquired. Consequently, in comparison with a case in which only the first signal intensities or the second signal intensities are acquired, the state of the touch panel 14 can be perceived more finely and in greater detail.

Within a range in which the first signal intensities and the second signal intensities behave, the first range AR1 and the second range AR2 exist which are highly reliable as an indicator for estimating the presence of contamination (refer to FIG. 3). In the self-capacitance mode, the first range AR1 is a range in which the signal intensities are less than the self-capacitance touch threshold STH_{TO} and in excess of the abnormality threshold STH_{AN}. Further, in the mutual capacitance mode, the first range AR1 is a range in which the signal intensities are greater than or equal to the positive side threshold MTH_{D1}. In the self-capacitance mode, the second range AR2 is a range in which the signal intensities are less than the self-capacitance touch threshold STH_{TO} and in excess of the abnormality threshold STH_{AN}. Further, in the mutual capacitance mode, the second range AR2 is a range in which the signal intensities are less than or equal to the negative side threshold MTH_{D2}.

According to the present embodiment, in the case that the second signal intensities at specified coordinates at which the first signal intensities are less than the self-capacitance touch threshold STH_{TO} and in excess of the abnormality threshold STH_{AN} are greater than or equal to the positive side threshold MTH_{D1} or less than or equal to the negative side threshold MTH_{D2}, it is determined that the touch surface corresponding to the specified coordinates is contaminated. In accordance with this feature, it is possible to correctly perceive that contamination is adhered to specified positions.

Further, within a range in which the first signal intensities and the second signal intensities behave, the third range AR3 exists which is highly reliable as an indicator for estimating the presence of contamination (refer to FIG. 3). In the self-capacitance mode, the third range AR3 is a range in which the signal intensities are greater than or equal to the self-capacitance touch threshold STH_{TO}. Further, in the mutual capacitance mode, the third range AR3 is a range in which the signal intensities are less than the mutual capacitance touch threshold MTH_{TO}.

According to the present embodiment, in the case that the second signal intensities at specified coordinates at which the first signal intensities are greater than or equal to the self-capacitance touch threshold STH_{TO} are less than the mutual capacitance touch threshold MTH_{TO}, it is determined that the touch surface corresponding to the specified coordinates is contaminated. In accordance with this feature, it is possible to correctly perceive that contamination is adhered to specified positions. Such a determination is useful in that contamination adhering from the touch surface to the outer side of the touch surface can be perceived.

Further, according to the present embodiment, the determination result is displayed on the screen of the display unit 12 on which the touch panel 14 is disposed. In accordance with this feature, it is possible to make the operator who operates the touch panel 14 grasp the state of the touch panel 14 while performing the touch operation.

[Exemplary Modifications]

The above-described embodiment may be modified in the following manner.

### (Exemplary Modification 1)

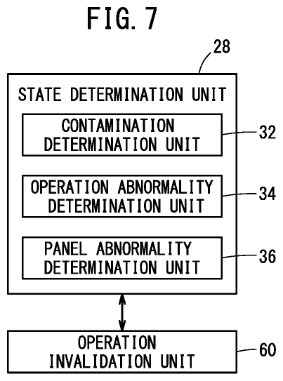

FIG. 7 is a block diagram illustrating the configuration of one portion of the diagnosis device 18 according to an Exemplary Modification 1. In FIG. 7, the same reference numerals are assigned to the same constituent elements as those described in the above embodiment. Moreover, in the present exemplary modification, descriptions that overlap or are duplicative of those stated in the embodiment will be omitted.

In the diagnosis device 18 according to the Exemplary Modification 1, an operation invalidation unit 60 is additionally provided. In the case that the operation abnormality determination unit 34 has determined that there is an operation abnormality with respect to the touch surface, the operation invalidation unit 60 invalidates the operation with respect to the specified coordinates detected by the operation abnormality determination unit 34 as being the operation positions. In accordance with this feature, it is possible to prevent an instruction from being executed on the basis of an unintended operation.

### (Exemplary Modification 2)

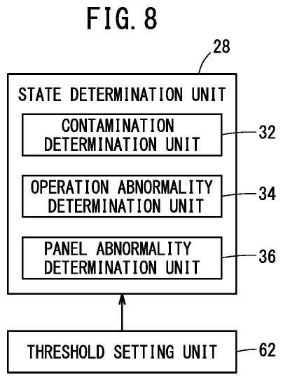

FIG. 8 is a block diagram illustrating the configuration of one portion of the diagnosis device 18 according to an Exemplary Modification 2. In FIG. 8, the same reference numerals are assigned to the same constituent elements as those described in the above embodiment. Moreover, in the present exemplary modification, descriptions that overlap or are duplicative of those stated in the embodiment will be omitted.

In the diagnosis device 18 according to the Exemplary Modification 2, a threshold setting unit 62 is additionally provided. The threshold setting unit 62, in response to an operation of the operator, sets at least one of the self-capacitance touch threshold STH_{TO}, the mutual capacitance touch threshold MTH_{TO}, the positive side threshold MTH_{D1}, the negative side threshold MTH_{D2}, or the abnormality threshold STH_{AN}. In accordance with this feature, it is possible to change the scale at which the state of the touch panel 14 is determined, in accordance with the environment or the like in which the touch panel 14 is arranged.

### (Exemplary Modification 3)

In the case that the first signal intensities and the second signal intensities continuously appear at the specified coordinates for a predetermined period of time, the contamination determination unit 32 may determine that the touch surface at the specified coordinates is contaminated. In accordance with this feature, it is possible to prevent an erroneous determination that the touch surface is contaminated due to momentary noise or the like.

### (Exemplary Modification 4)

The notification unit 30 need not necessarily be provided. Even if the notification unit 30 is not provided, it is possible for the state of the touch panel 14 to be perceived in fine detail. Further, it becomes possible to execute a process or the like in accordance with the state of the touch panel 14.

### (Exemplary Modification 5)

The above-described embodiment and Exemplary Modifications 1 to 4 may be arbitrarily combined within a range in which no technical inconsistencies occur.

### [Inventions]

A first invention and a second invention will be described below as inventions that can be grasped from the above-described embodiment and Exemplary Modifications 1 to 5.

### (First Invention)

The first invention is characterized by the diagnosis device (18) that diagnoses the electrostatic capacitive touch panel (14) that is capable of detecting signals based on each of self-capacitance and mutual capacitance, the diagnosis device including the control unit (24) that controls the touch panel in a manner so that detection of the self-capacitance signal and detection of the mutual capacitance signal are executed, the signal intensity acquisition unit (26) that acquires the first signal intensity detected based on the self-capacitance at each of the plurality of coordinates provided on the touch panel, and the second signal intensity detected based on the mutual capacitance at each of the plurality of coordinates, and the state determination unit (28) that determines the state of the touch panel based on each of the first signal intensities and each of the second signal intensities that are acquired. In accordance with such features, in comparison with a case in which only the first signal intensities or the second signal intensities are acquired, the state of the touch panel can be perceived more finely and in greater detail.

In the case that the second signal intensity at a specified coordinate at which the first signal intensity is less than the self-capacitance touch threshold (STH_{TO}) and exceeds the abnormality threshold (STH_{AN}) that is set to be lower than the self-capacitance touch threshold is greater than or equal to the positive side threshold (MTH_{D1}) that is set to be lower than the mutual capacitance touch threshold (MTH_{TO}), or is less than or equal to the negative side threshold (MTH_{D2}) that is set to be lower than the positive side threshold, the state determination unit may determine that the touch surface corresponding to the specified coordinate is contaminated. In accordance with such features, it is possible to correctly perceive that contamination is adhered to a specified position based on a range that is highly reliable as an indicator for estimating the presence of contamination, within a range in which the first signal intensities and the second signal intensities behave.

In the case that the second signal intensity at a specified coordinate at which the first signal intensity is greater than or equal to the self-capacitance touch threshold is less than the mutual capacitance touch threshold, the state determination unit may determine that the touch surface corresponding to the specified coordinate is contaminated. In accordance with such features, it is possible to correctly perceive that contamination is adhered to a specified position based on a range that is highly reliable as an indicator for estimating the presence of contamination, within a range in which the first signal intensities and the second signal intensities behave.

In the case that the first signal intensity and the second signal intensity appear continuously at the specified coordinate for a prescribed period of time, the state determination unit may determine that the touch surface is contaminated. In accordance with this feature, it is possible to prevent an erroneous determination that the touch surface is contaminated due to transient noise or the like.

In the case that the second signal intensity at a specified coordinate at which the first signal intensity is greater than or equal to the self-capacitance touch threshold is greater than or equal to the mutual capacitance touch threshold, the state determination unit may detect the specified coordinate as being the operation position, and in the case that the number of the operation positions thus detected exceeds the number-of-operation points threshold, the state determination unit may determine that an operation abnormality with respect to the touch surface exists. In accordance with such features, in comparison with the case in which the operation positions are determined using only the first signal intensities or the second signal intensities, an abnormality in the number of the operation points can be perceived more accurately.

The diagnosis device may further include the operation invalidation unit (60) which, in the case that the number of the operation positions exceeds the number-of-operation points threshold, invalidates the operation with respect to the specified coordinates detected by the state determination unit as being the operation positions. In accordance with this feature, it is possible to prevent an instruction from being executed on the basis of an unintended operation.

In the case that at least one of the first signal intensities is less than or equal to the abnormality threshold that is set to be lower than the self-capacitance touch threshold, the state determination unit may determine that the touch panel is abnormal. In accordance with this feature, it is possible to provide a notification to the operator who operates the touch panel that the touch panel is abnormal.

The diagnosis device may further include the notification unit (30) that issues a notification of the determination result of the state determination unit. In accordance with this feature, it is possible to make the operator who operates the touch panel grasp the state of the touch panel.

The notification unit may cause the determination result to be displayed on the screen of the display unit (12) on which the touch panel is disposed. In accordance with this feature, it is possible to make the operator who operates the touch panel grasp the state of the touch panel while performing the touch operation.

The notification unit may issue a notification of a message indicating a countermeasure for the determination result of the state determination unit. In accordance with this feature, it is possible to convey in an easily understandable manner how to carry out an improvement or the like when the state of the touch panel is poor.

The diagnosis device may further include the threshold setting unit (62) that sets, in response to an operation of the operator, at least one of the self-capacitance touch threshold, the mutual capacitance touch threshold, the positive side threshold, the negative side threshold, or the abnormality threshold. In accordance with this feature, it is possible to change the scale at which the state of the touch panel is determined, in accordance with the environment or the like in which the touch panel is arranged.

### (Second Invention)

The second invention is characterized by the diagnosis method for diagnosing the electrostatic capacitive touch panel that is capable of detecting signals based on each of the self-capacitance and the mutual capacitance, the diagnosis method including the control step (S1) of controlling the touch panel in a manner so that detection of the self-capacitance signal and detection of the mutual capacitance signal are executed, the signal intensity acquisition step (S2) of acquiring the first signal intensity detected based on the self-capacitance at each of the plurality of coordinates provided on the touch panel, and the second signal intensity detected based on the mutual capacitance at each of the plurality of coordinates, and the state determination step (S3) of determining the state of the touch panel based on each of the first signal intensities and each of the second signal intensities that are acquired. In accordance with such features, in comparison with a case in which only the first signal intensities or the second signal intensities are acquired, the state of the touch panel can be perceived more finely and in greater detail.

1. A diagnosis device, that diagnoses a touch panel that is an electrostatic capacitive touch panel configured to detect signals based on each of self-capacitance and mutual capacitance, the diagnosis device comprising:
a control unit configured to control the touch panel in a manner so that detection of a signal based on the self-capacitance and detection of a signal based on the mutual capacitance are executed;
a signal intensity acquisition unit configured to acquire a first signal intensity detected based on the self-capacitance at each of a plurality of coordinates provided on the touch panel, and a second signal intensity detected based on the mutual capacitance at each of the plurality of coordinates; and
a state determination unit configured to determine a state of the touch panel based on each of the first signal intensities and each of the second signal intensities that are acquired.

2. The diagnosis device according to claim 1, wherein
in a case that the second signal intensity at a specified coordinate at which the first signal intensity is less than a self-capacitance touch threshold and exceeds an abnormality threshold that is set to be lower than the self-capacitance touch threshold is greater than or equal to a positive side threshold that is set to be lower than a mutual capacitance touch threshold, or is less than or equal to a negative side threshold that is set to be lower than the positive side threshold, the state determination unit determines that a touch surface corresponding to the specified coordinate is contaminated.

3. The diagnosis device according to claim 1, wherein
in a case that the second signal intensity at a specified coordinate at which the first signal intensity is greater than or equal to a self-capacitance touch threshold is less than a mutual capacitance touch threshold, the state determination unit determines that a touch surface corresponding to the specified coordinate is contaminated.

4. The diagnosis device according to claim 2, wherein
in a case that the first signal intensity and the second signal intensity appear continuously at the specified coordinate for a prescribed period of time, the state determination unit determines that the touch surface is contaminated.

5. The diagnosis device according to a claim 1, wherein
in a case that the second signal intensity at a specified coordinate at which the first signal intensity is greater than or equal to a self-capacitance touch threshold is greater than or equal to a mutual capacitance touch threshold, the state determination unit detects the specified coordinate as being an operation position, and in a case that a number of the operation positions thus detected exceeds a number-of-operation points threshold, the state determination unit determines that an operation abnormality exists with respect to a touch surface.

6. The diagnosis device according to claim 5, further comprising an operation invalidation unit configured to, in the case that the number of the operation positions exceeds the number-of-operation points threshold, invalidate an operation with respect to the specified coordinates detected by the state determination unit as being the operation positions.

7. The diagnosis device according to claim 1, wherein
in a case that at least one of the first signal intensities is less than or equal to an abnormality threshold that is set to be lower than a self-capacitance touch threshold, the state determination unit determines that the touch panel is abnormal.

8. The diagnosis device according to claim 1, further comprising a notification unit configured to issue a notification of a determination result of the state determination unit.

9. The diagnosis device according to claim 8, wherein
the notification unit causes the determination result to be displayed on a screen of a display unit on which the touch panel is disposed.

10. The diagnosis device according to claim 8, wherein
the notification unit issues a notification of a message indicating a countermeasure for the determination result of the state determination unit.

11. The diagnosis device according to claim 2, further comprising a threshold setting unit configured to set, in response to an operation of an operator, at least one of the self-capacitance touch threshold, the mutual capacitance touch threshold, the positive side threshold, the negative side threshold, or the abnormality threshold.

12. A diagnosis method for diagnosing a touch panel that is an electrostatic capacitive touch panel configured to detect signals based on each of self-capacitance and mutual capacitance, the diagnosis method comprising:
a control step of controlling the touch panel in a manner so that detection of a signal based on the self-capacitance and detection of a signal based on the mutual capacitance are executed;
a signal intensity acquisition step of acquiring a first signal intensity detected based on the self-capacitance at each of a plurality of coordinates provided on the touch panel, and a second signal intensity detected based on the mutual capacitance at each of the plurality of coordinates; and
a state determination step of determining a state of the touch panel based on each of the first signal intensities and each of the second signal intensities that are acquired.

13. The diagnosis device according to claim 3, wherein
in a case that the first signal intensity and the second signal intensity appear continuously at the specified coordinate for a prescribed period of time, the state determination unit determines that the touch surface is contaminated.
